(19) United States
(12) Patent Application Publication
(10) Pub. No.: US 2004/0156884 A1
(43) Pub. Date: Aug. 12, 2004

(54) Emulsion impregnated rawhide chews with antimicrobially active chlorhexidine

(76) Inventors: Dale G. Brown, Wharton, TX (US); Ira D. Hill, Stafford, TX (US)

Correspondence Address: BANNER & WITCOFF, LTD., 28 STATE STREET, 28th FLOOR, BOSTON, MA, 02109-9601, US

(21) Appl. No.: 10/361,311

(22) Filed: Feb. 10, 2003

(51) Int. Cl. A23K 1/165; A23K 1/17

(52) U.S. Cl. 424/442

(57) ABSTRACT

Therapeutic rawhide pet chews impregnated throughout with a surfactant/polydimethylsiloxane emulsion containing chlorhexidine; suitable for releasing antimicrobially active chlorhexidine over the chew-life of the chew to help control biofilm formation and microbial activity throughout the pet oral cavity.

### FIELD OF THE INVENTION

The present invention is directed to novel therapeutic, emulsion impregnated rawhide pet chews suitable for controlling biofilms in pets, the fetid breath associated with biofilms and gum disease. These therapeutic rawhide chews are regularly introduced into the pet's oral cavity and release emulsions containing the substantive, chemotherapeutically active, antimicrobial, chlorhexidine, over the “chew-life” of the rawhide chew.

### BACKGROUND OF THE INVENTION

Unlike humans, pets do not chew and thoroughly masticate their food before swallowing. Because most of their teeth are sectorial in design (i.e., built for tearing and shredding meat from a carcass and not grinding), pets do not have serious problems with caries. That is, due to limited masticating, pets generally do not pack food and debris between their teeth like humans do. However, pets are domesticated carnivores, taken out of the wild. Accordingly, they no longer have the opportunity to regularly rip, tear and/or shred meat from the carcass of their prey. This lack of “carnivore-type” activity renders most domesticated pets vulnerable to gum disease.

Unfortunately, like their civilized owners, domesticated pets generally suffer from gum disease at about the same incidence as adult humans. For example, more than 86% of the dogs and cats older than four years of age that are brought to veterinary clinics have periodontal disease. See Colmery B., Front R., Vet. Clin. N. America, 18:891 (1982).

Periodontal disease is the overwhelming reason for tooth loss in dogs. Unfortunately, in most cases, treatment for periodontal disease must continue for the life of the pet, because of the pet's continued susceptibility and the chronicity of the disease. Groe T. K., The Compendium on Continuing Education, Vol. 564, No. 7, June 1982.

Periodontal disease in the domestic cat was studied by Rerchart P. A., et al., and reported in J. Periodont. Res., 19:67 (1984). Periodontal disease is the most common dental disease in cats. J. V. D., Vol. 5, No. 2, June 1988, and is the most prevalent disease condition found in cats today, Cats Magazine, 16-18, January 1987.

Periodontal problems are progressive. The first occurrence is the formation of plaque (more accurately described as biofilm), which is a transparent, adhesive fluid composed of the mucin in saliva, food particles, sloughed epithelial cells from the abrasive process of eating and the mouth's resident bacteria (usually aerobic Gram-positive, nonmotile cocci). The adhesive matrix that contains the bacteria is called the pellicle.

Soft plaque can be removed from teeth by the mechanical action of brushing. If plaque is not removed, the mineral salts in the saliva, particularly calcium carbonate, will precipitate into the plaque forming hard dental calculus (tartar). Eventually, this hard, rough-surfaced tartar is irritating to the tissue wall of the gingival sulcus. This irritation inflames the soft tissues.

Specifically, tartar can be defined as an incrustation of the teeth consisting of salivary secretion, food residue and various salts, such as calcium carbonate or phosphate.

When tartar or plaque (biofilm) collects on the teeth, it creates pressure on the gums causing them to become inflamed and to recede. Affected gums appear reddish-blue in color and bleed easily. Teeth in neglected pets may become loose. At this state, pus can be expressed from the surface of the gums when mild pressure is applied. Stoder E. and Stapley R. D., Veterinary Medicine/Small Animal Clinician, 1124, October 1973.

The organisms present in inflamed tissue are usually anaerobic, Gram-negative, motile bacilli. See: Eisner E. R., Veterinary Medicine, 97-104, January 1989, Frost R., Williams C. A., Vet. Clin. N. Amer., 16(5) 851-874 (1986); Harvey E. E., et al., Textbook of Veterinary Internal Medicine, W. B. Saunders, Philadelphia, Pa. (1982), pp. 1126-1187. Harvey C. E., Veterinary Dentistry, W. B. Saunders, Phila Pa. (1985), pp. 34-66, 956-199. Ross D. L., Current Veterinary Therapy, VI, W. B. Saunders, Phila Pa. (1977), pp. 918-921; Eisenmenger, E. Zetner C., Veterinary Dentistry, Lea & Febiger, Phila, Pa. (1985) pp. 131-150; Harvey C. E., Textbook of Small Animal Surgery, W. B. Saunders, Philadelphia, Pa. (1985), pp. 615-620. The depth of the gingival sulcus in dogs suffering from gum disease extends from a normal condition of 1-2 mm in depth to an abnormal condition of 3-4 mm in depth, or greater. The detachment of the gingiva and the formation of periodontal pockets begins at this depth of the gingival sulcus.

Of the several signs of periodontal disease readily evident to the examining veterinarian as well as the owner, the most common presenting sign is “halitosis”, i.e., “fetid breath”. Kyle M. A., J.V.D. Vol. 5, No. 2, June 1988. This bad breath is a byproduct of the infection in the mouth. Pain due to the bacterial toxins produced accompanies this condition. If the oral pain is severe enough, irritability and improper eating habits generally develop. Eisner E. R., Veterinary Medicine, 97-104, January 1989.

Biofilm formation in pets is an extremely complex process. Immediately after removal of bacteria from the tooth surface by prophylaxis, a ubiquitous layer of dental pellicle is formed on tooth surfaces. The early bacterial colonizers, mostly facultative gram-positive Streptococci and Actinomyces species, adhere to the dental pellicles on the tooth surface. Following the adherence of early colonizers, the biofilm increases its cell numbers mainly by bacterial growth.

The microbial composition of biofilms gradually becomes more diversified, and after two to three weeks, the biofilm becomes a mature bacterial community. During biofilm development, various types of bacterial adhesives mediate the attachment of the bacteria to receptors in dental pellicles or on the surface of other bacteria. See Davey and O'Toole, “Microbial biofilms: from ecology to molecular genetics” Microbiol. Mol. Biol. Rey. 64: 847-67 (2000).

Periodontitis can be prevented by keeping the pet's teeth clear of plaque and tartar buildup (biofilm), by regular cleansing of the teeth and gums or by periodic mechanical removal of tartar and/or plaque by an oral care professional. Studer E., Stapley R. D., Veterinary Medicine/Small Animal Clinician, 1124, October 1983.

According to Eisner E. R., “Basic home care consisting of regular brushing to maintain healthy teeth and gums is the cornerstone of treatment for periodontal disease in pets.” Veterinary Medicine, 698-708, July 1989.

Unfortunately, dental hygiene in pets is something that most owners neglect. Many pet owners are unaware that just like people, pets require regular dental care. Most pet treat manufacturers have attempted at one time or another to incorporate various oral hygiene benefits in their pet care products. To date, these oral care adjuncts to pet food, chews, treats, etc., have not proven too successful, as the previously referenced survey of oral hygiene of pets older than four years of age brought to veterinary clinics indicates.

Various rawhide chew toys have been the primary focus for attempting to remove and/or control biofilms in pets.

Rawhide is a byproduct of the slaughter of hoofed animals and consists of the hide, tendons, etc. of the animal. Rawhide contains about 65-70% water, 30-35% dry material and less than 1% ash. The dry material is largely made up of fibrous proteins, collagen, keratin, elastin and reticulin. Due to this high water content, previously known methods of processing rawhide required that the rawhide be dried before it is used to produce pet chews. For a detailed description of rawhide, see:

Chemical Technology: An Encyclopedic Treatment, Vol. V, Barnes & Noble Books, (1972), pages 392 to 406, is a general disclosure of types of leathers and their uses, and the tanning of leather. Arnold, John R., Hides and Skins, (1925), pages 6, 7, 252, 253, 310 and 311, is a general disclosure on raw and tanned hides and skins.

Footwear And Leather Abstracts, Information Retrieval Limited, Vol. II, No. 1, (1967), page 61, discloses several methods for the depilation of skins and raw hides and for processing raw hide.

North American Packer Hides, Pratt Bros. Co., (1939), page 107, defines rawhide leather as being hides that have been limed, dehaired and stuffed with oil or grease, but otherwise not tanned. Flemming, Louis, A., Practical Tanning, (1910), pages 81 to 83, describes methods of making lace leather.

Churchill, James E., “The Complete Book of Tanning Skins And Furs”, (1983), page 165, discloses how to make rawhide. Page 166 discloses that rawhide and objects made from rawhide will be eaten by dogs and other animals unless they are treated with mineral oil or another preservative.

Partridge, John, “Chemical Treatment of Hides And Leather”, (1972), pages 2 to 43, deals with the chemical preservation of raw hides and skins and the chemical dehairing of skins and hides. The treatments include: removing hair using a solution of lime containing an inorganic phospho-sulfur compound containing at least one P—S bond; and dehairing using enzymatic action with K₂HPO₄ as a pH adjuster.

Thorstensen, Thomas C., Practical Leather Technology, (1985), pages 1 to 41, deals with the preparation of hides.

Kirk-Othmer, Encyclopedia of Chemical Technology, 3^{rd} Ed., Vol. 14, (1981), pages 200 to 216, is a general article on leather. Pages 213, 215 and 216 disclose that polyphosphates are excellent pretannages for vegetable tanning. Optimum molecular weights of the polyphosphates are from 1500 to 2500. Also there is a minimum-effluent vegetable tanning system, known as the Liritan process. The limed and bated hides are treated for 24 hours in a pit with 5 percent of sodium hexametaphosphate (Calgon) solution and sufficient sulfuric acid to achieve a pH of 2.8 at the end of that time. This part of the process has become known as the Calgon pickle. The solution is reused daily, being regenerated with additional sodium hexametaphosphate and sulfuric acid, and is discarded only once a year. The treatment presumably prepares the hides for a more rapid vegetable tanning process, and the recommended one with varied concentration of wattle (mimosa) takes 11 days. The tanning liquors are recirculated and reused. Further finishing of leathers that have been prepared by the Liritan combination tannage process, as a non-effluent rapid tannage for sole leather, is used by sole-leather tanneries throughout the world.

Early methods of manufacturing pet chews out of substantially pure rawhide were as simple as preparing and drying rawhide strips until they were hard and bonelike. These nonmechanical methods consist of preparing the rawhide by removing, either chemically or otherwise, the fat and hair found in the cattle ligaments and other material which comprise the raw starting material. The treated rawhide is then split, cut and rolled into the desired shape, such as a rope or strip, and dried. Coloring, flavor additives and antitartar ingredients are applied to surfaces of the chew by coating or basting the outside of the rawhide strip once dry.

One of the simpler methods requires drying the cut rawhide in the sun, before the rolling step, in order to preserve the rawhide. Prior to the rolling process, the dried rawhide is dipped in water, making it soft and easier to roll. The rawhide therefore needs very little drying once rolled. However, this drying process results in yellow or brown bones which are generally unappealing to pet owners.

Another nonmechanical method consists of working with the rawhide in the wet state, possibly wringing the rawhide out before processing. Under this process, the rawhide is cut and rolled in the wet state.

The nonmechanical “clean, cut and dry” methods of producing pet chews are labor and energy intensive and time consuming. The methods are labor intensive because the treated skins are sorted depending on their size, laid out, cut into big strips, distributed to the workers who roll them into bones, placed on trays, shipped to the ovens and usually turned over once a day until dry. There are also problems with quality control. Because of all the manual work involved, the percentage of “seconds” and rejects is unreasonably high, compared to machine made products. These methods are energy intensive because the rawhide has to be dried slowly once rolled to obtain a hard (15% moisture content) product. Slow drying is necessary because of the risk of cooking the rolled product into gelatin. Typically the drying process can last up to 15-20 days, starting off with a very low temperature (approximately 50° C.) and gradually reaching 80° C. The drying can involve electric fans and wood heated air, running 24 hours a day.

In one preferred method of making rawhide products in accordance with the present invention, cowhides are split and thoroughly washed and cleaned of bacteria. The hide is treated and processed in the same manner as for conventional rawhide chew toys, with materials such as detergents, water and anti-hair materials. The washed hides are then sanitized, such as by being tumbled in liquid hydrogen peroxide and then thoroughly rinsed with water. Excess water is then removed, such as by pressing the hides between the nip of two pinch rollers. At this point, the hides are relatively soft and flexible, but may contain as much as 75% absorbed water. These hides are then ready for physical disruption/penetration to be followed by soaking.

Illustrative of a nonmechanical method for manufacturing rawhide chews is U.S. Pat. No. 5,149,550 to Mohilef (1992), which teaches the manufacture of pet chews by (1) washing ligaments from cattle and other hoofstock in an aqueous degreasing solution or roasting, thereby rendering the ligaments substantially free of fat, and (ii) drying until hard.

U.S. Pat. No. 5,047,231 to Spanier, et al., (1991) discloses a process for preparing rawhide by adding an inorganic pyrophosphate compound to rawhide strips and then drying the rawhide. The resultant pyrophosphate coated product, when chewed by the dog, reportedly results in reduced tartar accumulation on the dog's teeth.

In an effort to address the problem of choking and intestinal blockage associated with bulk rawhide, pet chew products have been developed utilizing rawhide that has been chopped, sliced, shredded, ground, pulverized or otherwise comminuted. The comminuted pieces are then wetted, optionally fortified with adhesives, resins, etc., and finally compacted or compression molded. Although the removal of a significant portion of the water during the molding process enhances the resulting product's integrity, the compression molding process nonetheless has its limits with regard to the ultimate strength characteristics of the final product. Limiting the moldings to relatively small sizes also serves to yield a stronger product, although peeling or delaminating is still a problem. While the disassociated particles tend to be of a physically small size and are therefore able to pass harmlessly through the dog's intestinal tract, ingestion thereof can nonetheless cause problems.

An additional approach has been employed in the past wherein comminuted rawhide, in combination with a variety of additives, is first compression molded and then baked. While the baking step has a sterilizing effect and thereby addresses the decay problem described above, the end product tends to be extremely hard and dense, and is therefore not particularly “chewable.” Moreover, due to its brittleness, it is quickly and easily shattered by a large dog, and consequently is quickly consumed.

In the course of subjecting the rawhide to melting temperatures during the injection molding process, the material becomes sterilized. This serves to interrupt any decaying process that may be in progress, and thereby alleviates the foul odor normally associated with rawhide chew toys. Furthermore, sterilization is achieved without baking the molded material so as to yield a very chewable product with a consistency and texture preferred by most dogs. By injection molding a molten medium, a substantially more cohesive product is formed than is possible using compression or compaction molding techniques.

### PRIOR ART

The prior art teaches there is a need: (a) to make frequent cleanings of the teeth of dogs more convenient, and (b) to make pet owners in control of that cleaning easier. To date, this need is substantially unmet.

A number of pet chew products have been developed over a long period of time in an attempt to address this long-felt need. For example, U.S. Pat. No. 3,882,257 to Cagle describes a pet food product in which a slurry is dehydrated and made into a simulated bone for dogs which can help exercise the jaws and gums and help to remove tartar from the teeth. U.S. Pat. No. 4,145,447 to Fisheret al., discloses an animal food which is chew resistant and can help remove plaque or tartar from animal teeth. Still another product of this type is disclosed in U.S. Pat. No. 5,094,870 to Scaglione, et al., which discloses a process for preparing dog biscuits containing at least one inorganic phosphate salt. The dog biscuits are (hopefully) chewed and/or eaten by the dog with the result that tartar accumulations on its teeth are reduced or prevented. U.S. Pat. Nos. 5,296,209 and 5,407,661, both to Simone, et al., describe a pet chew product having a flexible cellular matrix in which is contained a cellulose fibrous material such as corn cob fractions having a mechanical cleansing function, which, when chewed by the pet, is intended to effect a reduction in plaque, stain and tartar on the pet's teeth. While the foregoing approaches may be meritorious, they involve creating a unique food product (as distinguished from a “chew toy”), which is a relatively complex and expensive approach, and there is no guarantee that the resultant product will be accepted and actively consumed by dogs.

U.S. Pat. No. 5,100,651 to Boyer discloses a health product for the care of teeth of dogs, capable of being chewed or gnawed by the dogs, which contains fluoride, antimicrobial agents, and anti-decay agents.

U.S. Pat. No. 5,296,217 to Stookey discloses a method for preventing dental calculus using sequestering agents applied to commercially prepared diets of domestic animals. The sequestering agents form soluble calculus complexes in saliva and dental plaque, thereby preventing the calcifying dental plaques. Sodium hexametaphosphate has been utilized as a preferred sequestering agent. These sequestering agents can be added to dog treats, i.e., biscuits, and/or to the surface of chew toys such as rawhide.

U.S. Pat. No. 5,310,541 to Montgomery describes an animal chew product containing one or more enzymes and substrates for the purpose of generating antimicrobial compounds upon contact with animal saliva, for tartar prevention.

U.S. Pat. No. 5,431,927 to Hand et al., describes a pet food prepared from a fiber containing nutritionally balanced mixture of carbohydrates, protein, fat, vitamins and minerals. The product has an expanded striated structure matrix which fractures when chewed by a pet, creating a mechanical tooth cleansing function which acts to reduce plaque, stains and tartar on the pet's teeth.

U.S. Pat. No. 5,467,741 to O'Rourke discloses a chew toy for dogs which is molded from soft pliable threads twisted about one or more strands of twisted synthetic fibers. The twisted fibers are impregnated with one ore more breath freshening or flavoring agents so as to dispense the agent as the dog chews.

U.S. Pat. No. 5,618,518 to Stookey discloses a chew product containing sodium hexametaphosphate, which is useful against the buildup of dental calculus.

U.S. Pat. No. 5,904,614 to Cyr et al., discloses a food dog bone made of 93% casein, poultry meal, and gelatin, and 7% of an anti-tartar composition used in the control of tartar in domestic animals such as dogs.

U.S. Pat. No. 5,908,614 to Montgomery describes a peroxidase-activating oral care composition including an enzymatic water soluble hydrogen peroxide precursor and pH adjusting agent. The composition facilitates the rapid release of hydrogen peroxide and results in the activation of a peroxidase enzyme in an oral cavity.

U.S. Pat. No. 5,944,516 to Deshaies discloses a device for cleaning the teeth of a dog, consisting of brushes, onto which toothpaste is automatically dispensed during a brushing procedure.

U.S. Pat. No. 5,989,604 to Wolf et al., discloses a pet foodstuff and treatment method for reducing the incidence of dental caries in non-human animals. Xylitol containing foodstuff is used.

Early pet food jerky that was made by dehydrating low fat beef muscle tissue was highly palatable and could provide a reasonable “chew life” if sliced and dried in thick strips. Attempts have been made to toughen reformed jerky products to improve the “chew life”. Neilberger (U.S. Pat. No. 5,026,572) disclosed a multiple extrusion method of producing jerky by extruding a blend of wet beef and flour and then incorporating the cooked product of this first extrusion into a second extrusion step. Ray (U.S. Pat. No. 5,290,584) teaches the utilization of frozen mechanically separated meats that are comminuted to a small particle size and then mixed with pregelatinized flour prior to elevated temperature extrusion. Scaglione (U.S. Pat. No. 4,868,002) describes a process for making a tougher jerky using fibrous components of animal tissue or plant tissue such as wheat straw, alginates or industrial generated fibers.

Many long-lasting synthetic chews have been developed in attempts to address the “chew life” issue. Axelrod (U.S. Pat. No. 4,771,733) discloses a method whereby an aqueous based flavor or odor is incorporated into a polyurethane resin based dog chew to improve the palatability of the product. Axelrod attempted further improvements to this technology (U.S. Pat. No. 5,339,771) by dispersing an animal meal within the matrix of a synthetic thermoplastic molded bone. Axelrod also discloses (U.S. Pat. No. 5,240,720) an injection molded chew produced from rennet casein and gelatin which can be heated by the consumer in a microwave oven to cause the chew to expand and thereby render it more easily chewable.

Other literature references of interest include:

Kornman, Journal of Periodontol. Res., Supplement 5:22 (1986)

Chen, Journal of the California Dental Assoc., 2001.

Kolenbrander P. E., Methods Enzymol, 253 :385-97, 1995.

Kolenbrander, P. E., J. Applied Bacteriol., 78:795-865, 1993.

Grander S., J. Antimicrob. Chemother., 37:1047-50, 1996.

Davies D. G., Parsek M. R., Science, 280:295-8, 1998.

Papapanou P. N., Annu. Periodontol., 1:1-36, 1996.

Socransky S. S., Haffajee A. D., Periodontol. 2000, 5:7-25, 1994.

Moore W. E. C., Moore L. V. H., Periodontol. 2000, 5:66-77, 1994.

Socransky S. S. Haffajee A. D., J. Periodontol., 63:322-31, 1992.

Zambon J. J., Annu. Periodontol., 1:879-932, 1996.

Whittaker C. J., Klier C. M., Kolenbrander P. E., Annu. Rev. Microbiol., 50:513-52, 1996.

Wilson M., Patel H., Fletcher J., Oral Microbiol. Immunol., 11:188-192, 1996.

It is known in the art to apply a coating on rawhide chews by using a baste. Conventional baste may be used to provide desired coloring and/or flavoring or odor to make the chew toy more appealing to pets and their owners. Particular baste formulations can provide a more natural-looking color that pet owners are more inclined to purchase. For example, U.S. Pat. No. 5,673,653, issued to Sherrill on Oct. 7, 1997 (Sherrill), col. 1, lines 55-65, discloses various types of bastes applied to rawhide chew toys.

Other Patent references of interest include:

U.S. Pat. Nos. 6,350,438; 5,114,704; 5,011,679; 4,260,635; 4,702,929; 5,609,913; 5,673,653; 5,827,565; 4,674,444; 5,100,651; 4,546,001; 4,364,925; 5,200,212; 6,365,133; 5,476,069; 5,635,237; 5,215,038; 5,329,881 and 5,467,741.

The effect of chewing rawhide “chips” (Chew-eez®, Superior Brands, Inc.) was compared with a leading cereal biscuit (Milk Bone®, Nabisco Brands, Inc.) on the removal of calculus in dogs reported in Jayma, Vol. 197, No. 2, Jul. 15, 1990, to with: “ . . . rawhide removed calculus considerably better than cereal biscuits for the study period.” In U.S. Pat. Nos. 5,009,973 and 5,015,485 assigned to Nabisco Brands, Inc., cereal biscuits (similar to Milk Bone®) containing pyrophosphate were reported to prevent tartar accumulation on the teeth of dogs. However, the chewing and eating of 12 such biscuits a day was required by a small dog to achieve the effect reported. This comprises 25 to 33% of the small dog's daily caloric requirement.

The act of regularly chewing an object (such as rawhide) sufficiently rigid to allow for an oral residence time of greater than thirty seconds or so has been shown to result in reduced tartar accumulation compared to a quickly consumable object, such as a biscuit (Lags, et al., J. Am. Veterinary Medical Association., 197, pp. 213-219 (1990).

Particularly relevant additional U.S. Patents include:

U.S. Pat. Nos. 6,074,662; 6,223,693; 6,277,420; 6,238,715; 6,350,438; 6,165,474; 5,047,231; 6,365,133; 6,159,508; 6,309,676; 5,635,237; 5,114,704; 5,011,679; and 6,365,133.

Chew toys for dogs perform several important functions. First, and most importantly, these toys facilitate several health functions, such as teeth and gum cleaning, gum massage and chewing exercise. Benefits of these functions include the prevention of periodontal disease and tartar buildup, as well as the promotion of healthy teeth and jaw development. Dogs often do not have access to natural bones and hard objects that scour their teeth when chewed and assist in healthy dental development, and owners must sometimes look to toys or snacks in order to fill this void. A variety of artificial chew toys have been created in an attempt to achieve these health benefits, with varying degrees of success. For instance, artificial chew toys have been made from rawhide, woven fibers, and ropes. However, these materials are often rapidly destroyed by the chewing action which breaks down the fibers and structure of the material, and the soft nature of these products cannot provide the same degree and variety of health benefits that can be obtained from chew toys that are comprised of harder material.

Another important function of chew toys is to divert destructive chewing behavior and to provide amusement and entertainment for the animal. Chew toys can provide an outlet for the animal to expend its chewing energies which might otherwise by directed in a destructive manner on household objects. The degree of acceptability of the toy by the animal will determine the effectiveness and success of the product in this regard. Additionally, the toy should have an appeal to the animal and offer a means of entertainment and amusement to keep the dog happy over time, preferably over long periods of time. Therefore, it should be appreciated that there exists a need for an improved chew toy that will generate a longer period of sustained interest by dogs, thereby imparting needed health and entertainment for the animal.

Rawhide pet chews are a preferred means for cleaning tooth surfaces and fighting biofilm formation in pets. Depending on their shape and size, rawhide pet chews are generally chewed for extended periods, while effectively controlling, removing, disrupting and/or weakening biofilms through the normal physical/cleaning actions associated with the rawhide mastication process, referred to hereinafter as “physical/cleaning-type action”.

Such rawhide chew products typically have a useful life (referred to hereinafter as “chew life”) of several minutes to several hours. This “chew life”, in addition to providing cleaning-type action, provides an ideal means for continually transferring biofilm disrupting ingredients contained throughout the rawhide to the teeth and gums of the pet as taught and claimed by the present invention.

To date, therapeutic rawhide pet chews, where the therapeutic agent is added to the surface of the rawhide, have had, at best, marginal success in contributing to rawhide's physical/cleaning/controlling, removing and/or disruption of biofilms from the teeth of pets suffering from gum disease. Additionally, such surface treatments of rawhide chews, invariably result in staining of rugs, carpeting, upholstery, etc., which has become a major “turn-off” to pet owners.

The use of chlorhexidine in periodontal treatment is described in the following references:

Soskolne, et al., J. Periodontol., 68(1): 32-38 (1987 January)

Vandekerckhove, et al., J. Periodontol., 67(12): 1251-1259 (1996 December)

Christie, et al., J. Chin. Periodontol., 25(1): 15-23 (1988)

Walsh, et al., J. Chin. Periodontol., 19(4): 245-248 (1992)

Bollen & Quirynen, J. Periodontol., 67(11): 1143-1158 (1996)

Bollen, et al., J. Clinical Periodontol., 23(10): 960-970 (1996)

Addy, et al., J. Oral Rehabil., 23(4): 219-231 (1996)

Shiloah & Patters, J. Periodontol., 67(2): 130-139 (1996)

Valente, et al., J. Can. Dent. Assoc., 62(1): 46-48 (1996)

Smith, et al., J. Chin. Periodontol., 23(1): 19-23 (1996)

Quirynan, et al., J. Dent. Res., 74(8): 1459-1467 (1995)

Ozean, et al., J. Nihon Univ. Sch. Dent., 36(3): 191-198 (1994)

Shiloah & Patters, J. Periodontol., 65(6): 458-578 (1994)

Baker, Curr. Opin. Periodontol., 89-98 (1993)

Chapple, et al., J. Periodontol., 63(10): 812-816 (1992)

Reynolds, et al., J. Chin. Periodontol., 19(8): 595-600 (1992)

Foirellini & Paquette, Curr. Opin. Dent., 2: 63-79 (1992)

Berswanger, et al., J. Chin. Dent., 3(2): 33-38 (1992)

Stabholz, et al., Chin. Rev. Dent., 13(5): 9-14 (1991)

Meurman, et al., J. Chin. Periodontol., 18(8): 587-591 (1991)

Stabholz, et al., J. Periodontol., 62(7): 429-433 (1991)

Needleman, Br. Dent. J., 170(11): 405-408 (1991)

Osterneal, et al., J. Chin. Periodontol., 18(4): 245-251 (1991)

Osterneal, et al., J. Chin. Periodontol., 18(2): 97-100 (1991)

Jolkovsky, et al., J. Periodontol., 61(11): 663-669 (1990)

Cervone, et al., Endod. Dent. Travmatol, 6(1): 33-36 (1990)

Taggart, et al., J. Chin. Periodontol., 17(1): 32-37 (1990)

Newman, et al., J. Periodontol., 60(10): 577-581 (1989)

Sanz, et al., J. Periodontol., 60(10): 570-576 (1989)

Southard, et al., J. Periodontol., 60(6): 302-309 (1989)

Wennstrom, et al., J. Chin. Periodontol., 14(10): 573-580 (1987)

Wennstrom, et al., J. Chin. Periodontol., 14(9): 541-550 (1987)

Bollen.et al., J. Chin. Periodontol., 25(1): 56-66 (1998)

The following additional references cover: (a) chlorhexidine, (b) chlorhexidine treatments for pets. and (c) pet products for fighting plaque, tartar and/or gingivitis:

Addy, “Chlorhexidine compared with other locally delivered antimicrobials. A short review. J. Clin. Periodontol. 13: 957-964, (1986).

“This brief review of antimicrobials in supragingival plaque control indicates that to date, chlorhexidine is the most effective and safe antiplaque agent available. The published information for efficacy suggests chlorhexidine cold theoretically be substituted for the toothbrush in supragingival plaque control.”

Rawlings, et al., “Effect on Canine Oral Health of Adding Chlorhexidine to a Dental Hygiene Chew.” J. Vet. Dent., 15(3): 129-134 (1998).

“Incorporation of chemical antiplaque agents in oral hygiene products is a way of augmenting mechanical cleaning procedures in controlling supragingival plaque formation, thus helping to prevent the onset of early periodontal disease.”

Gorrel and Rawlings, “The Role of a Dental Hygiene Chew in Maintaining Periodontal Health in Dogs.” J. Vet. Dent., 13(1): 31-34 (1996).

“The study demonstrated that the dally addition of the chew to the dry diet was effective in reducing plaque and calculus accumulation on the tooth surfaces.”

Gorrel, et al., “Effect of a New Dental Hygiene Chew on Periodontal Health in Dogs.” J. Vet. Dent., 16(2): 77-81 (1999).

“Daily addition of the chew to the dry diet was effective in reducing plaque and calculus accumulation on the tooth surfaces, and also reduced the severity of gingivitis and oral malodor as compared to feeding the dry diet only.”

Hennet, “Effectiveness of an Enzymatic Rawhide Dental Chew to Reduce Plaque in Beagle Dogs,” J. Dent. Vet., 18(2): 61-64 (2001).

“The rawhide dental chew provided in the study reported here decreases plaque formation in the prevention of progressive periodontal disease associated with attachment loss if provided on a long-term basis.”

Hennet. “Effectiveness of a Dental Gel to Reduce Plaque in Beagle Dogs.” J. Vet. Dent., 19(1): 11-14(2002).

“The dental gel (containing eblorhexidine) applied in the study reported here decreases plaque accumulation in the short term and may be beneficial in reducing the severity of gingivitis associated periodontal disease if provided on a long-term basis.” (The gel used was Virbac's DentiVet.)

Goldstein, et al., “The effect of rawhide strips in the removal and prevention of plaque and calculus.” Proc. Vet. Dent. Forum, p. 29 (1993).

Goldstein, et al., “Beefhide strips in the maintenance of dental health.” Pro. Vet. Dent. Forum., p. 81 (1994).

Duke, “How a chewing device affects calculus buildup in dogs,” Vet. Med., 84: 1110-1114 (1999).

Eley, British Dental Journal Vol. 186(6): 286-295, March 27, 1999.

Smith, et al., “The efficacy of an anti-gingivitis chewing gum,” J. Clin. Periodontol., 23: 19-23 (1996).

Tellefsen, et al., “Use of chlorhexidine chewing gum significantly reduces dental plaque formation compared to similar xylitol and sorbitol products,” J. Periodontol., 67: 181-183 (1996).

Bonesvoll, et al., Arch. Oral Biol., 19 (1974) 209.

R. Schrott and Loe, J. Periodontol. Res., 7 (1972) 192.

Jones, Periodontol. 2000, 1997. 1:55-62.

Gorrel and Bierer, J. Vet. Dent., 1999. 16:109-133.

As noted above, chew toys for dogs perform several important functions. First, and most importantly, these toys facilitate several health functions, such as teeth and gum cleaning, gum massage and chewing exercise. Benefits of these functions include the prevention of periodontal disease and tartar buildup, as well as the promotion of healthy teeth and jaw development. Dogs often do not have access to natural bones and hard objects that scour their teeth when chewed and assist in healthy dental development, and owners must sometimes look to toys or snacks in order to fill this void.

A variety of artificial chew toys have been created in an attempt to achieve these health benefits, with varying degrees of success. For instance, artificial chew toys have been made from rawhide, woven fibers, and ropes. However, these materials are often rapidly destroyed by the chewing action which breaks down the fibers and structure of the material, and the soft nature of these products cannot provide the same degree and variety of health benefits that can be obtained from chew toys that are comprised of harder material.

Another important function of chew toys is to divert destructive chewing behavior and to provide amusement and entertainment for the animal. Chew toys can provide an outlet for the animal to expend its chewing energies which might otherwise by directed in a destructive manner on household objects. The degree of acceptability of the toy by the animal will determine the effectiveness and success of the product in this regard. Additionally, the toy should have an appeal to the animal and offer a means of entertainment and amusement to keep the dog happy over time, preferably over long periods of time. Therefore, it should be appreciated that there exists a need for an improved chew toy that will generate a longer period of sustained interest by dogs, thereby imparting needed health and entertainment for the animal.

Rawhide pet chews are a preferred means for cleaning tooth surfaces and fighting biofilm formation in pets. Depending on their shape and size, rawhide pet chews are generally chewed for extended periods, while effectively controlling, removing, disrupting and/or weakening biofilms through the normal physical/cleaning actions associated with the rawhide mastication process, referred to hereinafter as “physical/cleaning-type action”.

Such chew products typically have a useful life (referred to hereinafter as “chew life”) of several minutes to several hours. This “chew life”, in addition to providing cleaning-type action, provides an ideal means for continually transferring biofilm disrupting ingredients such as chlorhexidine to the pet's oral cavity. Unfortunately traditional chlorhexidine containing rawhide pet chews do not release antimicrobial active chlorhexidine due to the substantivity of chlorhexidine to the protein the rawhide chew.

To date, therapeutic rawhide pet chews, where a therapeutic agent such as chlorhexidine is added to the surface of the rawhide, have had, at best, marginal success in contributing to rawhide's physical/cleaning/controlling, removing and/or disruption of biofilms from the teeth of pets suffering from gum disease. And, these surface treatments of rawhide chews, invariably result in staining of rugs, carpeting, upholstery, etc., which has become a major “turn-off” to pet owners.

Chlorhexidine digluconate at 0.12% has been marketed in the U.S. since about 1986 as an Rx rinse for treating gingivitis in humans under the brand, Peridex®. Clinically-based antigingivitis efficacy of Peridex® is attributed primarily to chlorhexidine's substantivity. Antimicrobial activity from 6 to 12 hours is reported for chlorhexidine. Other chlorhexidine salts are also suitable for purposes of the present invention. These include the diacetate, dilactate, etc.

Various species of bacteria are thought to be involved in the pathogenesis of periodontal disease. Chlorhexidine is a broad spectrum antimicrobial agent. The mechanism by which chlorhexidine exerts antimicrobial effects is not well defined, but may include damage to the bacterial cell wall through action similar to that of a surfactant.

The antimicrobial spectrum of activity of chlorhexidine includes vegetative gram-positive and gram-negative bacteria inclusive of vegetative anaerobes. Chlorhexidine is inactive against bacterial spores except at elevated temperatures. Chlorhexidine has antifungal activity with this activity being greater against the yeast forms than the mold forms. The level of activity varies with the species of the fungi. As is the case with bacterial spores chlorhexidine is inactive against fungal spores. Chlorhexidine has been shown to have clinically relevant activity against those bacteria which have been associated with periodontal disease.

Studies in 1964 demonstrated that chlorhexidine was an effective agent for disinfecting the oral mucosa covering a periodontal infection, Birch, et al. (1964) “A comparison of root canal and apical lesion flora,” Brit. Journal Dent., 116: 350-352; and for disinfection of root canals, Atkinson and Hampson (1964) “Sterilization of root canals,” Brit. Journal Dent., 117: 526-528.

The first clinical studies on the plaque inhibitory effects of chlorhexidine (Hibitane®) were reported by Renggii (1968) Med. Diss. Zurich; Mühlemann (1973) Odontolonica Acta, 17: 99-103; Loë and Schiött (1970) “Dental Plaque” Ed. McHugh, W. D., 1970, Edinburgh; Gjermo, Baastad and Rölla (1970) P. Journal Period. Res., 5: 102-109; Flötra, Gjermo, et al. (1972) Scand. Journal Dent. Res., 80: 10-17; Loë, Schiött, et al. (1976) Journal Period. Res., 11: 35-144. Cationic chlorhexidine salts possess a strong affinity to hydroxyapatite and to acidic proteins on the tooth surface, according to Rölla, Loë and Schiött (1970) Journal Period. Res., 5: 90-95.

The calculus (tartar)-inhibiting capacity of chlorhexidine has been studied by Schroeder (1969) “Formation and Inhibition of Plaque”, pp. 145-162, Beme, Stuttgart, Vienna, Hans Huber Publisher.

In 1970, Loë and Schiött, reported results of the first group of an extensive list of investigations which clearly documented that chlorhexidine was the most effective anti-plaque and anti-gingivitis agent which had been evaluated up to that time. Loë and Schiött (1970) J. Period. Res., 5: 79-83.

The toxicity for chlorhexidine is low. Rats have been shown to tolerate 0.05 and 0.2% aqueous solutions of chlorhexidine as the only source of drinking water for more than six months without detectable interference with growth and reproduction: Davies, et al. (1954) Brit. J. Pharmacology, 9: 192-196.

Since 1954, chlorhexidine salts have been used clinically for disinfection of operation sites, in the treatment of burns and in urology and gynecology: Beeuwkes and DeVries (1956) Lancet II, pp. 913-914; Grant & Findley (1957) Lancet II, pp. 862-863; Lowbury, et al. (1964) Brit. Medical Journal II, pp. 531-536; Gillespie, et al. (1964) Brit. Medical Journal II, pp. 423-425.

The effect of chlorhexidine in disinfection of the oral mucosa has been reported by Cawson and Curson, 1959, Brit. Dental Journal, 107: 69-70.

Of prime importance to chlorhexidine safety were the long term trials demonstrating the safety of the antiseptic with no systemic or serious local side effects observed after two years continuous use. Nuki, et al. (1976) J. Periodont. Res., 11(3): 172-175; Schiött, et al. (1976) J. Periodont. Res., 11(3): 153-157.

As noted above, the substantivity of chlorhexidine poses a problem to adding chlorhexidine to rawhide treats. That is, the chlorhexidine, when added to rawhide from an aqueous soak, attaches to rawhide protein and is no longer available as an antimicrobial anti-biofilm agent when the chlorhexidine containing rawhide is chewed. As detailed below, soaking fresh rawhide in chlorhexidine aqueous solutions results in the chlorhexidine penetrating the rawhide; however, the chlorhexidine substantivity moiety attaches the chlorhexidine to the rawhide such that microbially active chlorhexidine is not available to the pet's oral cavity when the chlorhexidine treated rawhide is subsequently chewed. This “tie-up” of chlorhexidine by the rawhide is observed for fresh and dried rawhide, each impregnated with chlorhexidine.

### OBJECTS OF THE INVENTION

An object of the present invention is to provide therapeutic rawhide chews suitable for controlling, removing and/or disrupting biofilms in pets and controlling gum disease.

A further object of the invention is to provide rawhide pet chews impregnated substantially throughout with antimicrobially active chlorhexidine that is releasable as an active antimicrobial during chewing over the life of the chew for the purpose of helping to control biofilms in pets.

Another object of the invention is to provide a process for treating rawhide pet chews substantially throughout with chlorhexidine that is releasable in a therapeutically active state into the oral cavity of pets during chewing to help control biofilms.

Still another object of the invention is to provide a treatment for gum disease in pets comprising periodically providing the pet with rawhide chews impregnated substantially throughout with antimicrobially active chlorhexidine digluconate which is released during chewing over the chew life of the pet chew onto the surfaces of the pet's teeth and gums.

Another object of the invention is to enhance the palatability of therapeutic rawhide pet chews.

Another object of the invention is to provide various processes for physically disrupting/penetrating and soaking rawhide pet chews in order to impregnate them substantially throughout with biofilm disrupting emulsions containing antimicrobially active chlorhexidine, for subsequent release into the oral cavity of pets during chewing over the chew-life of the chew.

Still another object of the invention is to provide a treatment for pet gum disease, comprising periodically providing the pet with rawhide chews impregnated substantially throughout with biofilm disrupting emulsions containing chlorhexidine, which release over the chew life of the chew antimicrobially active chlorhexidine onto the surfaces of teeth and gums.

Yet another object of the invention is to improve rawhide pet chews by impregnating substantially throughout with antimicrobially active chlorhexidine in an emulsion also containing other ingredients that are releasable over the chew-life of the product.

A further object of the invention is to provide a wide range of fresh, dried and comminuted rawhide pet chews impregnated substantially throughout with emulsions containing antimicrobially active chlorhexidine that is releasable over the chew-life of the chew.

### SUMMARY OF THE INVENTION

The present invention is directed to therapeutic rawhide pet chews impregnated substantially throughout with an emulsion containing antimicrobially active chlorhexidine. Surprisingly, the chlorhexidine impregnated substantially throughout the rawhide pet chew in various emulsions is releasable in an antimicrobially active state to help chemotherapeutically control biofilm formation on the teeth of pets. The method of manufacturing these therapeutic rawhide pet chews, and the treatment of biofilms and gum diseases in pets, using these therapeutic pet chews, are also included in the presented invention. These therapeutic rawhide chews are neither taught nor suggested by the prior art referenced above.

The present invention is directed to rawhide pet chews impregnated substantially throughout with biofilm disrupting emulsions containing chlorhexidine. Unexpectedly, antimicrobially active chlorhexidine is releasable over the chew-life to help control biofilm formation on the teeth of pets and treat gum disease in pets.

The emulsions containing antimicrobially active chlorhexidine are impregnated substantially throughout the rawhide chew irrespective of size, shape, or whether the rawhide to be impregnated is fresh or has already been dried or comminuted.

The emulsion containing chlorhexidine rawhide chews of the present invention can be distinguished from traditional basted and/or coated rawhide pet chews described in the prior art. For example:

The chlorhexidine containing emulsion is impregnated substantially throughout the rawhide pet chews of the present invention.

The chlorhexidine released from the treated rawhide pet chew of the present invention is releasable and antimicrobially active over the chew-life of the chew.

The emulsions containing chlorhexidine are releasable over the chew-life of the product at levels substantially greater than those available from basting and/or other surface coating processes. This results in superior biofilm fighting/cleaning attributes over the chew-life of the impregnated rawhide product.

A distinctive, unexpected, plasticized effect is achieved with the pet chews of the present invention, wherein the impregnated rawhide chews demonstrate an extended chew-life attributed to the intrinsic toughness associated with this increased plasticity.

Enhanced pet preference is characteristic of the impregnated pet chews of the present invention which is apparently due to the flavor, mouth feel additives, conditioners, etc., distributed substantially throughout the rawhide chew along with the emulsions containing chlorhexidine. This pet preference is available over the chew-life of the impregnated product.

Enhanced texture is attributed to the impregnated pet chews of the present invention which is apparently due in part to the humectants, softening agents, conditioners, etc., included in the emulsion containing chlorhexidine, which is distributed and retained throughout the impregnated rawhide chew.

Enhanced pet owner acceptance attributed to the rawhide chew being impregnated substantially throughout with various flavorants, conditioners, mouthfeel agents, etc., that encourage pet chewing.

Particularly preferred emulsions for impregnating substantially throughout the rawhide pet chews of the present invention include MICRODENT® and ULTRAMIJLSION®, as described in detail below.

The biofilm disrupting/controlling properties of MICRODENT® emulsions in humans has been extensively documented using chewing gums and mints as a MICRODENT® emulsion delivery vehicle. For example, reductions in plaque greater than 35% have been reported in clinical studies on chewing gums containing up to about 2% by weight MICRODENT® emulsion. Other clinical studies on MICRODENT® emulsion containing mints showed plaque reductions of about 20% with up to about 2% by weight MICRODENT® emulsion. It has been suggested that MICRODENT®D emulsion impregnated rawhide pet chews of the present invention would, like chewing gum, continuously release the anti-biofilm MICRODENT® emulsion into the pet's oral cavity while the pet is chewing the impregnated rawhide chew.

The masticating of rawhide pet chews provides an excellent physical cleaning action for pet teeth, which is particularly effective in controlling newly formed biofilm, particularly when this physical cleaning is combined with the release of a MICRODENT® emulsion which simultaneously coats the entire oral cavity with this substantive, surface-energy altering emulsion containing antimicrobially active chlorhexidine, as the biofilm is being disrupted by the physical cleaning action.

In addition to their biofilm disrupting properties, the preferred MICRODENT® and ULTRAMULSION® emulsions are particularly effective as carriers for antimicrobially active chlorhexidine and other active ingredients as well as various flavorants, conditioners, mouthfeel agents, etc., the latter of which tend to encourage aggressive chewing and maintain pet interest in the therapeutic rawhide pet chew throughout its chew-life.

### BRIEF DESCRIPTION OF THE DRAWINGS

FIG. 1 illustrates rawhide penetrated by a patterned arrangement of fibrillated slits.

FIG. 2 illustrates rawhide penetrated by a generally closely spaced pattern of needle punctures.

FIG. 3 illustrates rawhide penetrated by a generally widely spaced pattern of needle punctures.

FIG. 4 illustrates rawhide penetrated by a patterned arrangement of similar sized drilled holes.

FIG. 5 illustrates rawhide penetrated by a patterned arrangement of two different sized punched holes.

### DEFINITIONS OF KEY TERMS

For the purposes of the present invention, the following key terms are defined as set out below:

“Rawhide” is defined as the byproduct of the slaughter of hoofed animals and consists of the hide, tendons, etc. The dry material is largely made up of fibrous proteins, collagen, keratin, elastin and reticulin. Rawhide products originate from the natural skins of animals. In addition to cows, animal skins, such as pig, goat and water buffalo skins can also be used. To form rawhide, a cow or other animal hide is split. The top grain is generally tanned and formed into leather products. The bottom half of the hide is generally kept in its natural “raw” state. Hides in such natural, untanned state, are generally referred to as rawhide. One common use for rawhide is the production of chemicals such as gelatin. Another important use for rawhide is the manufacture of edible chew toys for pets, such as dogs.

“Rawhide pet chew toys” are defined as consumable pet chews, which are free from bacteria, as well as dangerous substances such as formaldehyde and other preservatives which can be used to prevent the rawhide from becoming contaminated by bacteria, microbes, maggots and the like. A rawhide chew toy is also free from processing chemicals commonly used in the tanning of leather which make the leather soft. Not only are these unhealthy for a dog, but training a dog to chew on a toy which smells like leather could fool a dog into thinking that it is acceptable to chew on a shoe or leather handbag. In order to make rawhide chew toys acceptably resistant to bacterial contamination, rawhide chew toys are commonly sold in a substantially dehydrated state. An acceptably low moisture content can lead to a safe or stable water activity. Thus, if the water activity of the rawhide article is too high, there is a possibility that the chew toy will be contaminated by mold, bacteria and the like, or otherwise become unsanitary and potentially harmful for the pet. Thus, rawhide pet chew toy products contain less than about 13% moisture in order to have an acceptable water activity below about 0.75.

“Water activity” is defined by Encyclopedia of Food Science, AVI Publishing as the ratio of the vapor pressure exerted by the water contained in the product to the vapor pressure of pure water at the same temperature. The lower the water activity of a product, the less susceptible that product is to the growth of bacterial, fungal and yeast organisms. Fruits, bread and meat all have water activities above 0.95. In contrast, crackers, cereal and sugar can have a water activity as low as 0.1.

Rawhide also includes other animal parts such as ears and snouts. That is, dried ear and ear pieces consist primarily of a section of hard-firm ear cartilage with a piece of skin (rawhide) on each side. The resultant dog chew, comprised of an ear which includes two pieces of rawhide and hard cartilage sandwiched there between provides prolonged chewing time over similarly available chews manufactured solely of rawhide, resulting in consequently increased abrasive effect on the teeth surfaces. More particularly, there is provided a pet chew product comprising an inner layer of cartilage sandwiched between opposing outer layers of animal skin. The inner layer of cartilage preferably comprises a dried animal ear portion, and the outer layers of animal skin preferably comprise rawhide.

“Impregnated rawhide” is defined as physically disrupted/penetrated rawhide that has distributed substantially throughout emulsion containing antimicrobially active chlorhexidine that has been introduced into the physically disrupted/penetrated rawhide by means of soaking the rawhide in a water bath containing said emulsion.

“Periodontal disease” (“gum disease”) is a broad term used to describe those diseases which attack the gingiva and the underlying alveolar bone supporting the pet's teeth. The disease exists in a number of species of warm blooded animals such as canines and felines, and includes a series of diseases exhibiting various syndromes which vary from each other according to the stage or situation of the disease or the age of the pet. The term is used for any inflammatory disease which initially occurs at a marginal gingiva area and may affect the alveolar bone. Periodontal disease affects the periodontium, which is the investing and supporting tissue surrounding a tooth (i.e., the periodontal ligament, the gingiva, and the alveolar bone). Two common periodontal diseases are gingivitis (inflammation of the gingiva) and periodontitis (inflammation of the periodontal ligament manifested by progressive resorption of alveolar bone, increasing mobility of the teeth, and loss of the teeth at advanced stage). Other terms used for various aspects of periodontal disease are “acute necrotizing ulcerative gingivitis” and “alveolar pyorrhea”. Periodontal disease may involve one or more of the following conditions: inflammation of the gingiva, formation of periodontal pockets, bleeding and/or pus discharge from the periodontal pockets, resorption of alveolar bone, loose teeth and loss of teeth. Periodontal disease is generally considered to be caused by/associated with bacteria which are generally present in dental plaque which forms on the surface of the teeth and in the periodontal pocket. Thus, known methods for treating periodontal disease often include the use of antimicrobials and/or anti-inflammatory drugs.

“Alveolar bone resorption” is defined as the loss of osseous tissue from the specialized bony structure which supports the teeth. Such resorption has many causes including, but not limited to, natural remodeling following tooth extraction, scaling and root planing and the progression of periodontal disease.

“Biofilm (plaque),” the precursor of dental calculus/tartar, is defined as a community of bacteria embedded in exopolysaccharide that adheres to tooth surfaces and are a major source of the infections associated with gum disease in pets. The early bacterial colonizers of biofilm, which are mostly faculative gram-positive Streptococci and Actinomyces species, adhere to the dental pellicles on the tooth surface. Following the adherence of early colonizers, the biofilm increases its cell numbers mainly by bacterial growth.

“Dental calculus,” or tartar as it is sometimes called, is defined as a deposit of hardened plaque (biofilm) which forms on the surfaces of the teeth at the gingival margin. Supragingival calculus appears principally in the areas near the orifices of the salivary ducts; e.g., on the lingual surfaces of the lower anterior teeth and on the buccal surfaces of the upper first and second molars, and on the distal surfaces of the posterior molars. Mature calculus consists of an inorganic portion which is largely calcium phosphate arranged in a hydroxylapatite crystal lattice structure similar to bone enamel and dentin. An organic portion (biofilm) is also present and consists of desquamated epithelial cells, leukocytes, salivary sediment, food debris and various types of microorganisms.

As the mature calculus develops, it becomes visibly white or yellowish in color unless stained or discolored by some extraneous agency. In addition to being unsightly and undesirable from an aesthetic standpoint, the mature calculus deposits are constant sources of irritation of the gingiva and thereby are a contributing factor to gingivitis and other diseases of the supporting structures of the teeth, the irritation decreasing the resistance of tissues to endogenous and exogenous organisms.

“Surfactants” are defined as surface active agents suitable for ingestion. Said Surfactants have the property of being water soluble with a propensity to emulsify water-insoluble coating agents (as defined below), and to hold the coating agent in an aqueous suspension as an emulsion when the mixture is dispersed in water or saliva. Suitable surfactants, illustrative of the types of substances suitable for use in impregnated rawhide of the present invention, are further detailed below.

“Coating Agents” are defined as water insoluble or very slightly soluble substances which, when presented to the oral cavity in an emulsified state, will coat the teeth, gums and oral cavity tissue with a thin film of the coating agent. This film has several beneficial properties which are functionally described below.

“Conditioners” are defined as water-soluble substances, usually of high molecular weight, which in combination with the surfactant and coating agent condition (1) the rawhide, making it more flexible, tough and fresh cartilage-like with improved chewing properties and (2) the oral cavity, providing improved palatability by creating a mouthfeel more akin to fresh animal cartilage, bone and tissue. Suitable conditioners, illustrative of the types of substances suitable for use in impregnated rawhide of the present invention, are further detailed below.

“MICRODENT®” and “ULTRAMULSION®” are defined as hot melt emulsions of biofilm disrupting coating substances such as polydimethylsioxane in surfactants such as nonionic poloxamer surfactants and include those emulsions described in U.S. Pat. Nos. 4,950,479; 5,032,387; 5,057,309; 5,538,667; 5,651,959 and 5,711,936. These patents are incorporated herein by reference. The clinical plaque effect obtained when certain of these combinations of surfactants and coating substances are introduced into the mouths of humans are detailed in Food & Drug Administration (FDA) Docket No. 81N-0033, OTC Volumes 210246 to 210262 and 210339 dated Jun. 17, 1991, filed in response to the FDA call-for-data as reported in the Federal Register, Sep. 19, 1990, 55 Fed Reg., 38560, Vol. VI of said filing; the summary is specifically incorporated herein by reference.

“Impregnating” is defined as a means of physically penetrating/disrupting rawhide in combination with soaking with emulsions to affect distribution of said emulsions substantially throughout the rawhide. Impregnating can be achieved by certain substances by simply soaking the rawhide in solutions/dispersions of such substances until the substances have penetrated throughout the rawhide chew. Alternatively, in those instances where substances, such as the emulsions of the present invention containing antimicrobially active chlorhexidine and other ingredients, achieve minimal penetration of the rawhide substrate under various soaking conditions, the rawhide substrate is physically disrupted/penetrated using various physical means to disrupt/penetrate the rawhide, thereby augmenting penetration throughout the rawhide with those various emulsions that do not, on their own, penetrate the rawhide during various soaking procedures. To achieve “impregnating,” various physical means of physically disrupting/penetrating rawhide can be utilized including: punching, drilling, fibrillating, meshing, scoring, etc., randomly or in a predetermined pattern In one embodiment the rawhide can be disrupted/penetrated physically by contacting stretched rawhide with a rotating fibrillator device such as described in U.S. Pat. No. 5,578,373. The individual disruptions/penetrations can be shaped into stars, bone-like shapes, round protrusions, etc., or remain essentially undefined protrusions. The level of penetration can be modest to high and can be random, patterned or combinations thereof.

“Emulsion Impregnated Rawhide” is defined as rawhide penetrated substantially throughout with an emulsion containing chlorhexidine that is antimicrobially active. MICRODENT® and/or ULTRAMULSION® can be “impregnated” into fresh, disrupted/penetrated, rawhide by means of a marinating process, whereby the fresh hides soak in a MICRODENT® and/or ULTRAMULSION®/water mixture for extended periods at temperatures ranging from room temperature to elevated temperature. Alternatively, the MICRODENT® and/or ULTRAMULSION® can be added to dried rawhide chews, etc., by soaking the dried chews, which have been physically disrupted/penetrated, etc., at varying temperatures over a wide range of soaking periods. Various “impregnating” means are detailed in the Tables and Examples set out below. The rawhide to be treated with MICRODENT® or ULTRAMULSION® can be fresh; however it is preferable to impregnate “preformed chew toys” that have already been physically disrupted/penetrated and dried. In addition, comminuted rawhide generally produced from trimmings, etc., of formed rawhide toys and treats, i.e., knotted bones, is also suitable, particularly for pet chews that can be used with no adverse effect to the pet due to choking, blockage, etc.

“Comminuted rawhide” is defined as processed rawhide that is molded, pressed, shaped. etc. Comminuted rawhide includes rawhide pieces that are particularized into small sized particles which are shaped into various chews that, when the particles break off from the chew during chewing, they can be readily swallowed and passed through the dog's digestive system without blockage.

“Chew time” is defined as the duration that a pet treat can be chewed, gnawed, licked. etc., by a pet before it is consumed. Chew time defines the period for transferring therapeutic ingredients, such as biofilm disrupting emulsion, which are contained in MICRODENT® “impregnated” rawhide pet chews and released during chewing into the oral cavity to treat bio films and gum disease.

A “substantially impregnated-throughout rawhide treat” is defined as rawhide which is physically disrupted/penetrated throughout as a means of augmenting the “impregnation” throughout the rawhide with emulsions, conditioners, surfactants, etc.

“Chlorhexidine” is defined as various chlorhexidine salts including the digluconate (1,1-hexamethylene bis [5-(p-chlorophenyl)biguanide]di-D-gluconate. Chlorhexidine digluconate is a salt of chlorhexidine and gluconic acid. It is a strong base, practically insoluble in water. Solubility is dependent on the salt form. Chlorhexidine digluconate is the most soluble form of chlorhexidine. Its chemical structure is:

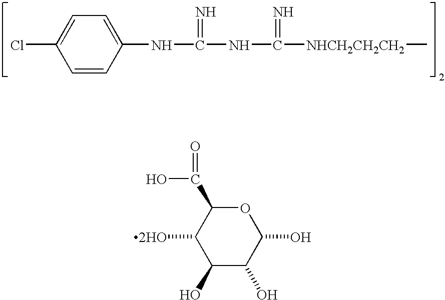

### DETAILED DESCRIPTION OF PREFERRED EMBODIMENTS

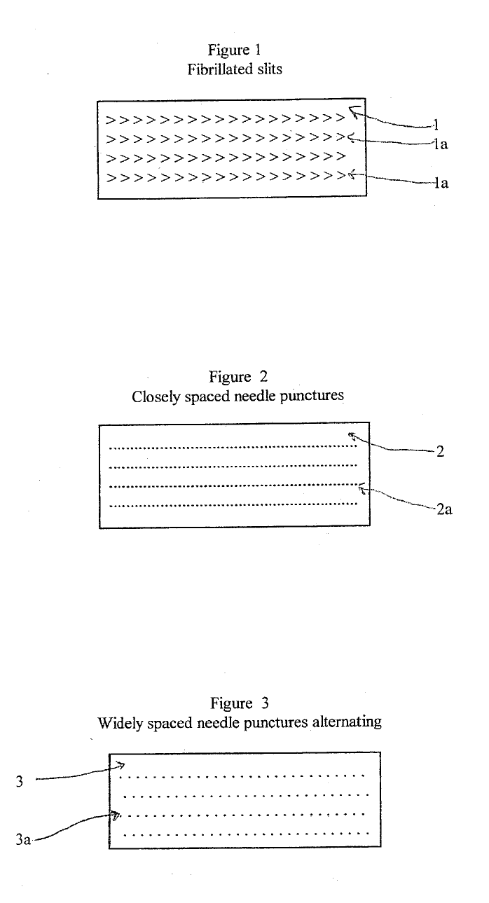

Referring to FIGS. 1 through 5, various means of penetrating and types of penetrated rawhide are illustrated.

Referring to FIG. 1, fibrillated slits, 1a, penetrate rawhide, I, in a patterned fashion, which results in high internal surface exposure for the impregnated rawhide while providing an easier to chew. substantially impregnated throughout rawhide treat.

Referring to FIG. 2, closely spaced needle punctures, 2a, penetrate rawhide, 2, in a closely spaced, patterned fashion, which results in a stronger, substantially impregnated throughout, rawhide treat that is stronger, but slower to impregnate.

Referring to FIG. 3, widely spaced needle punctures, 3a, penetrate rawhide, 3, in a widely spaced alternating pattern, which results in an impregnated rawhide treat that is much stonger, but slower to impregnate.

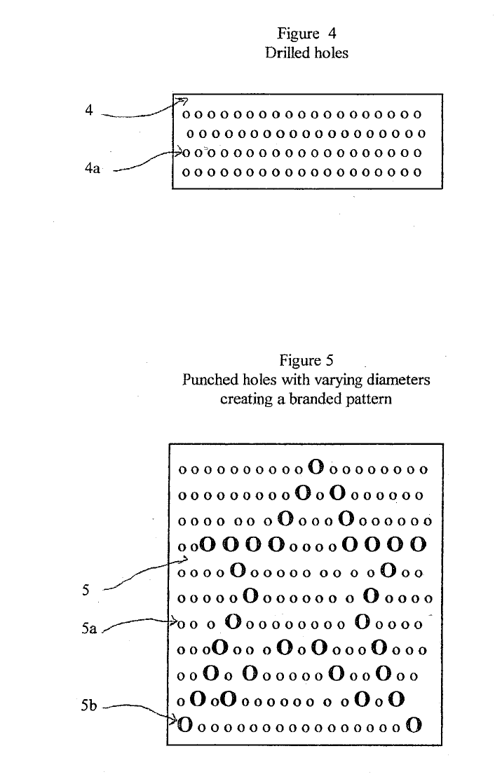

Referring to FIG. 4, similar sized, drilled holes, 4a, penetrate rawhide, 4, in a patterned arrangement, which allows for faster impregnation with high internal surface, high impregnation and an excellent visible signal.

Referring to FIG. 5, two different sized, punched holes, 5a and 5b, penetrate rawhide, 5. in a patterned arrangement, which provides high internal surface with excellent impregnation and a highly visible and recognizable pattern.

The extraordinary saliva flow in carnivores is substantially greater than in humans, and, as a result most therapeutic substances released from the coatings on rawhide chews during chewing or introduced via toothpaste, rinses, etc., are readily flushed by the saliva flow from the oral cavity, usually before the therapeutic substance can have any substantial therapeutic effect in the pet's mouth.

The substantivity of the emulsions containing antimicrobially active chlorhexidine of the invention to tooth and gum surfaces plays a most critical role in effective biofilm therapy of pets. The preferred “pet applied” emulsion application is via “emulsion impregnated” rawhide chews of the present invention, where the “emulsion impregnated” substantially throughout the rawhide uses various rawhide physical disrupting/penetrating means to augment the “impregnation” with various emulsions of the invention.

It has been discovered that when physically disrupted/penetrated rawhide pet chews are treated throughout with emulsions such as MICRODENT® and/or ULTRAMULSION® containing chlorhexidine, surprisingly, these emulsions are consistently releasable from the chew and at biofilm disrupting levels into the oral cavity during the chew-life of the pet chew and unexpectedly the chlorhexidine released is antimicrobially active. These emulsions also contain various other ingredients including conditioners, mouthfeel agents and flavorants which encourage the pet to chew and retain the pet's interest in chewing.

A fundamental shortcoming with rawhide has been that basic rawhide is not particularly palatable and dogs generally lose interest in the product after a relatively short time. Manufacturers have attempted to overcome this shortcoming by coating or basting the rawhide with flavorings, but these overcoatings are usually applied onto the surface and are quickly licked off and/or consumed by the dog, leaving untreated, unpalatable rawhide that is generally unappealing to the pet. In addition, these surface basted coatings tend to soil and/or stain surfaces in the house such as carpeting, rugs, upholstery, etc.

The unexpected availability of emulsions, such as MICRODENT® and ULTRAMULSION® containing antimicrobially active chlorhexidine released from rawhide pet chews over the chew-life of the chew, allows pet owners to now control biofilms in their pets by simply routinely providing pets with rawhide chews impregnated with MICRODENT® or ULTRAMULSION®, which emulsions contain antimicrobially active chlorhexidine, flavorants, conditioners, mouthfeel agents, etc., where the latter render the rawhide chew most palatable. These rawhide impregnated emulsions can be delivered to the pet's oral cavity with minimal staining and/or soiling of household surfaces in contrast to that experienced heretofore with basted rawhide chews.

Surprisingly, the impregnating of fresh rawhide with MICRODENT® containing chlorhexidine minimizes the “tying up” of the chlorhexidine with the protein of the rawhide pet chew and allows for the release of chemotherapeutically active chlorhexidine at effective levels.

The release of antimicrobially active chlorhexidine from dried rawhide that is impregnated with chlorhexidine and MICRODENT® combined is a primary feature of the invention.

As noted above, the extraordinary saliva flow in carnivores is substantially greater than in humans. As a result, most antimicrobials and other active ingredients released from rawhide chews during chewing or introduced via toothpaste, rinses, treats, etc., are readily flushed by the pet's saliva flow from the oral cavity before the antimicrobial or other active ingredients can have any substantial antimicrobial effect in the pet's mouth.

It is not surprising that the substantivity of chlorhexidine is its most appealing feature and should play a most critical role in effective biofilm therapy of pets. Unfortunately, to date, this has not been the case. The present invention offers an innovative application for pets based on various chlorhexidine/MICRODENT® impregnated rawhide chews, as detailed in the Examples and discussed below.

It has now been discovered that when rawhide pet chews are treated with MICRODENT® or ULTRAMULSION® emulsions containing chlorhexidine, which emulsions are impregnated substantially throughout the rawhide pet chew, surprisingly, antimicrobially active chlorhexidine is subsequently released from the chew into the oral cavity over the chew-life of the pet chew.

The unexpected availability of antimicrobially active chlorhexidine from MICRODENT®/chlorhexidine containing rawhide pet chews allows pet owners to now control biofilms and, to some extent gum disease, in their pets by routinely providing their pets with rawhide chews impregnated substantially throughout with MICRODENT® and antimicrobially active chlorhexidine.

Thus, the rawhide pet chews of the present invention provide a unique combination of therapeutic and physical treatment of biofilms, neither taught nor implied in the prior art.

That is:

(1) The chlorhexidine/MICRODENT® impregnated rawhide chews of the present invention release antimicrobially active chlorhexidine onto tooth and gum surfaces throughout the mouth of the pet over the chew-life of the rawhide; and

(2) This release of chlorhexidine is accompanied by a physical abrasive/chewing-type action which is supported with improved plasticizing, texture and pet appeal of the chew attributed to the impregnated emulsion substantially throughout the chew. These emulsion impregnated chews offer the pet improved shredding, gnawing, ripping, biting, etc., that is normally associated with a dog chewing prey in the wild.

This combination of physical abrasive/cleaning-type action with the chlorhexidine chemotherapeutic treatment of biofilm effectively controls biofilm formation and removes and/or disrupts biofilm. Key to the efficacy of this combination is the fact that the MICRODENT®/chlorhexidine impregnated rawhide chew also contains flavorants, conditioners, mouthfeel agents, etc., that “mask” the “off-taste” of the chlorhexidine that is released into the mouth. That is, these masking flavorants, conditioners, mouthfeel agents, etc., actually do more than mask the chlorhexidine taste; they actually also promote and encourage chewing by the pet. Flavorants, conditioners, mouthfeel agents, etc., with high pet acceptance flavor profiles such as peanut butter, chicken, liver and gravy-type flavors are preferred.

The melt emulsions described as MICRODENT® and ULTRAMULSION®(D are preferred carriers for “impregnating antimicrobially active chlorhexidine throughout” the therapeutic pet chews of the invention. These are described in detail in the MICRODENT® and ULTRAMjULSION® U.S. Patents to Hill et. a!., referenced above.

Generally, these melt emulsions comprise a coating agent emulsified in surfactants, such as:

sodium lauryl sulfate,

sodium lauryl sarcosinate,

polyethyleneglycol stearate,

polyethyleneglycol monostearate,

coconut monoglyceride sulfonates,

soap powder,

sodium alkyl sulfates,

sodium alkyl sulfoacetates,

alkyl polyglycol ether carboxylates such as those described in U.S. Pat. No. 4,130,636 polyoxyethylene derivatives or sorbitan esters, such as those described in U.S. Pat. No. 4,130,636,

polyoxyethylene derivatives or sorbitan esters, such as those described in U.S. Pat. Nos. 3,639,563 and 3,947,570,

propoxylated cetyl alcohol as described in U.S. Pat. No. 2,677,700. and

Preferred commercially available substances which include:

polyoxyethylene-polyoxypropylene block copolymers such as Pluronic F108, and F127 (BASE) and polysorbates such as Tween 40 and 80 (Hercules);

Particularly preferred surfactants include block copolymers

comprising a congeneric mixture of conjugated polyoxypropylene and polyoxyethelene compounds having a hydrophobe, a polyoxypropylene polymer of at least 1200 molecular weight; such as described in U.S. Pat. Nos. 4,343,785; 4,465,663; 4,511,563 and 4,476,107.

Suitable coating substances for these melt emulsions can be functionally described as follows, and they:

(1) suppress the tendency of the surfactant cleaners present to foam,

(2) are safely ingestible at the concentrations used,

(3) have an affinity for mouth and teeth surfaces,

(4) are neutral, inert and do not support biological activity,

(5) modify the surface energy properties of surfaces of the mouth which they coat such that it is more difficult for food particles, cellular debris and various plaque precursors and formers to attach to these emulsion coated surfaces, and

(6) form a thin, transparent, transient coating that does not build up on mouth surfaces and is removed by the normal cleaning and flushing action of the mouth.

Those coating substances suitable for the melt emulsions of the invention include various silicones, long chain hydrocarbons, carbowaxes and polymers such as:

silicone glycol co-polymers,

polydimethyl siloxanes at viscosities up to 2.5 million cs,

long chain hydrocarbons, especially normal paraffins having a chain length of 16 carbon atoms or greater, paraffins with several loci of branching and unsaturation does not create unacceptable toxicity nor lower the solidification point below body temperature,

Carbowaxes® (polyethylene glycols) and polymers which have limited solubility in ethanol and water solutions where the ethanol or water ratio is greater than 0.3:1 but have essentially no solubility in water or saliva at lower ratios.

Those conditioners suitable for impregnation of rawhide to improve its properties of flexibility, toughness and chewing properties are primarily selected from several classes of high molecular weight substances such as:

Purified, soluble proteins such as sodium caseinate, various cereal glutens. albumins and the like,

Starches and modified starches,

Soluble cellulose derivative such as carboxymethylcellulose, hydroxymethylcellulose, and hydroxypropylcellulose,

Polyhydroxyalcohols such as hydrogenated glucose syrup,

Polyethylene and polyproplyene glycols, and

Water soluble resins such as Gantrez®.

In addition, low molecular weight polyols such as glycerin and sorbitol and other humectants may also serve as conditioners, either in combination with high molecular weight substances such as the above or alone.

The “impregnating” of rawhide chews with emulsions of the present invention, such as MICRODENT® and/or ULTRAMULSION® containing chlorhexidine, requires augmenting by physically disrupting/penetrating means in order to provide for “impregnating” substantially throughout the rawhide.

In a preferred embodiment of the intention, various rawhides are subjected to mechanical force in the form of needles and/or punches in the presence of a liquid containing the oral care actives of the invention to prepare a rawhide chew that is substantially impregnated throughout with these substances. This simultaneous physical disruption/penetration of the rawhide in the presence of the impregnating substance allows the treatment to force the substances substantially throughout the rawhide to be released gradually during chewing.

In addition to the MICRODENT® and/or ULTRAMULSION® containing chlorhexidine, various other ingredients that are soluble or dispersible in said emulsions can also be “impregnated” throughout the rawhide chews. These other ingredients include:

toothpaste ingredients including anti-tartar ingredients including: sodium hexametaphosphate, tetrasodium pyrophosphate, various other pyrophosphates and sequestering agents, etc.,

whitening ingredients such as calcium peroxide, carbamide peroxide, etc.,

anti-caries ingredients including: sodium fluoride, fluorohexametaphosphate, stannous fluoride, etc.,

flavorants, conditioners, and mouthfeel agents, and

abrasives.

“Impregnating” these various other ingredients substantially throughout the rawhide chew. As distinguished from coating the surface of the chew with these ingredients allows the “impregnated” ingredients to be available consistently to the oral cavity of the pet at effective levels; over the chew-life of the rawhide pet chew. This availability of various “impregnated” ingredients consistently over the chew-life of the pet chew plays a key role in effectively controlling biofilm buildup, the fetid breath associated with biofilms and controlling the formation of tartar or calculus.

In addition to “impregnating” rawhide chews with emulsions containing antimicrobially active chlorhexidine of the present invention, these emulsions generally will preferably also contain various flavorants, conditioners, mouthfeel agents, etc., which are also “impregnated” substantially throughout the rawhide. These flavors, conditioners, mouthfeel agents tend to encourage the pet to chew the rawhide more intensely for longer periods and/or more frequently than the pet would normally do with rawhide that is not emulsion “impregnated” with flavorants, conditioners, mouthfeel agents, etc. Thus. flavor/conditioner/mouthfeel agent/emulsion “impregnated” rawhide is a more effective means for delivering antimicrobially active chlorhexidine into the pet's oral cavity, than rawhide chews that are not flavor/conditioner/mouthfeel agent/emulsion “impregnated.”

Further, the flavor/conditioner/mouthfeel agent/chlorhexidine containing emulsion “impregnated” rawhide chews of the present invention are more effective in physically cleaning pet tooth surfaces due to the “drive-to-chew” attributed to the flavorants, conditioners, mouthfeel agents, etc., distributed substantially throughout the emulsion “impregnated” chew. This intense “drive-to-chew” prompted by the flavorant and other ingredients impregnated throughout the rawhide chew results in more vigorous: chewing, gnawing, ripping and/or shredding action by the pet than is normally associated with rawhide that is not so “impregnated” throughout with flavor/conditioner/mouthfeel agents/emulsions.

In addition to including flavorants, conditioners, mouthfeel agents and/or active ingredients in the emulsions to be “impregnated” in rawhide chews, the present invention also includes the addition of other ingredients such as dispersible abrasives into these emulsions. The distribution substantially throughout the rawhide chew of an emulsion of MICRODENT® and/or ULTRAMULSION® containing anti-tartar active ingredients and also containing, dispersed therein, various abrasives of various particle sizes, provides an in-situ-type toothpaste formulation that is continuously worked over tooth surfaces as the MICRODENT® and/or ULTRAMULSION® containing antimicrobially active chlorhexidine and abrasives dispersed therein is released from the rawhide chew during chewing by the pet.

Release of various active ingredients such as chlorhexidine and some fluorides from the “impregnated” rawhide chew during chewing introduces off-flavors that tend to be a “turn-off” to pets. That is, the release of such off-flavors is usually associated with eventual rejection of the chew by the pet and, ultimately, failure of the pet to control biofilms and fetid breath.

It has been discovered that various flavorants, conditioners, mouthfeel agents, etc., included in the MICRODENT® and ULTRAMULSION® emulsions containing chlorhexidine impregnated throughout the rawhide chews neutralize certain “turn-off” flavors and adverse mouth feelings associated with various active ingredients when these ingredients are “impregnated” into rawhide chews. It has unexpectedly been found that the “impregnated” rawhide chews of the present invention containing chlorhexidine and certain neutralizing flavorants, conditioners, mouthfeel agents. etc., are generally preferred over untreated rawhide chews and are generally more effective in controlling pet biofilms and fetid breath.

As discussed above, the most effective flavorants for the “impregnated” rawhide chews of the present invention are generally unacceptable to pet owners. That is, the flavors preferred by pets tend to trend towards the odor and flavor of rotten, foul and/or decayed meats generally associated with “road kill” and dead, decaying, putrifying carcasses. These foul odors are a turn-off to pet owners and heretofore have generally been avoided for use with coated pet rawhide chews.

The process for “impregnating” rawhide (fresh, dried or comminuted) with the various emulsions, includes physical disruption/penetration of the rawhide chew followed by soaking and “marinating” the rawhide under a wide range of conditions including:

Soaking baths with various emulsions at levels from between about 0.1% and about 50% by weight of the soaking medium.

Soaking temperatures from between room temperature and about 80° C.

Soaking durations from between about 30 minutes and about 24 hours.

Soaking pressures ranging from open vessels under no additional pressure to closed pressurized systems at from between about 10 and about 100 psi.

Rinsing to remove various substances used in “impregnating” the rawhide from the surface of the rawhide so that the surface contains a minimum of those substances that have been used to “impregnate” the rawhide.

Drying with and without forced air at temperatures from between about room temperature and about 85° C. for periods ranging from between about 4 hours and 48 hours.

The invention is further described and illustrated by the various illustrative examples described in detail below.

Tables 1 through 4 include illustrative examples of the present invention, where various types and shapes of rawhide chews are impregnated using various physical disrupting/penetrating means, followed by soaking with various substances containing chlorhexidine under a wide range of soaking and drying conditions. Assays of the impregnated rawhide extract indicate that the chlorhexidine salt and some of the substance in which it is contained would be released from the rawhide chew and would be available for the biofilm therapy of the pet to be treated.

TABLE 1

| | Rawhide | | | | | | |
|---|---|---|---|---|---|---|---|
| | (fresh or dried) | | | | | | |
| | (type of physical | Emulsion surfactant | Emulsion Soak | | | | |
| | penetration) | coating composition | Conditions | Chlorhexidine | | Other Ingredients | Drying Conditions |
| | [Reference | PDMS (viscosity) | (temp° C.) | Salt | Conditioners | in Emulsion (in | (temp ° C.) |
| Ex. No. | is to FIGS. 1-5] | [% emulsion in soak] | [time in hours] | in Emulsion (in %) | (% of total solids) | %) | [time in hours] |
| 1 | chips | nonionic poloxamer/ | (room temp) | chlorhexidine | hydroxypropyl | toothpaste | (120) |
| | (fresh) | PDMS (2.5 million cs) | [12] | digluconate | cellulose | (5) | [12] |
| | [1] | [3] | | (2) | (32) | | |
| 2 | roll-up | nonionic poloxamer | (80) | chlorhexidine | carboxy methyl | whitening | (100 - forced |
| | (dried) | PDMS (2.5 million cs) | [4] | digluconate | cellulose | (8) | hot air) |
| | [2] | [6] | | (4) | (10) | | [6] |
| 3 | roll-up | nonionic poloxamer | (room temp) | chlorhexidine | Gantrez ® Resin | fluoride | (80) |
| | (fresh) | PDMS (500,000 cs) | [24] | digluconate | (10) | (6) | [8] |
| | [3] | [3] | | (8) | | | |
| 4 | chips | nonionic poloxamer | (80) | chlorhexidine | -none- | abrasive | (80 - forced |
| | (dried) | PDMS (12,500 cs) | [48] | digluconate | | (12) | hot air) |
| | [4] | [8] | | (8) | | | [12] |

TABLE 2
Emulsion Impregnated Dried Rawhide Chews with Chlorhexidine

| | Types of Dried | | Chlorhexidine | | | | | | | |
|---|---|---|---|---|---|---|---|---|---|---|
| | Chews (Type | Emulsion Type | digluconate | | | | | | | |
| | of physical | (level of PDMS | (% by wt) | | | | | | Rinsing with | Drying |
| | penetration) | in %) | Other ingredients | Conditioners | Water Soak Conditions | | | | warm water | Temp in |
| Ex. | [Reference is to | [concentration of | in Emulsion | (% of total | Temp | Time in | | Pressure | (duration in | C/time in |
| No. | FIGS. 1-5] | emulsion %] | [% by wt] | solids) | ° C. | hrs | Agitation | (in psi) | min) | hr |
| 5 | chip | poloxamer 407 | (1) | hydrogenated | room | 0.5 | constant | 100 | none | 70/8 |
| | [1] | (1) [5] | toothpaste [5] | glucose syrup (16) | temp | | | | | |
| 6 | chip | poloxamer 407 | (2) | wheat gluten | room | 1 | constant | 50 | 5 | 140/4 |
| | [2] | (2) [10] | whitening [8] | (10.5) | temp | | | | | |
| 7 | chip | poloxamer 407 | (3) | PEG 8000 (9) | 60 | 4 | intermittent | 50 | 10 | 180/4 |
| | [3] | (5) [4] | tartar control [3] | | | | | | | |
| 8 | chip | poloxamer 407 | (4) | hydroxypropyl | 75 | 8 | intermittent | 10 | 5 | 80/48 |
| | [4] | (10) [3] | anti-caries [4] | cellulose (3) | | | | | | |
| 9 | chip | poloxamer 407 | (6) | -none- | 75 | 12 | constant | 10 | 10 | 100/24 |
| | [5] | (10) [8] | abrasive [12] | | | | | | | |
| 10 | very thick | poloxamer 407 | (6) | Gantrez ® Resin | 75 | 16 | none | none | none | 120/16 |
| | [1] | (5) [20] | vitamin [6] | (10) | | | | | | |
| 11 | twist | poloxamer 407 | (7) | carboxy methyl | 80 | 24 | none | none | 5 | 100/12 |
| | [2] | (2) [30] | conditioner [4] | cellulose (10) | | | | | | |

TABLE 3
Emulsion Impregnated Wet Rawhide Chews with Chlorhexidine

| | Types | | | | | | | | |
|---|---|---|---|---|---|---|---|---|---|
| | of Wet Chews | | | | | | | | |
| | (Type of physical | Emulsion Type (level | Other | | | | | Rinsing with | |
| | penetration) | of PDMS in %) | ingredients in | Water Soak Conditions | | | | warm water | Drying Temp |
| Ex. | [Reference is to | [concentration of | Emulsion | Temp | | | Pressure (in | (duration in | in ° C./time in |
| No. | FIGS. 1-5] | emulsion in %] | (% by wt) | ° C. | Time hrs) | Agitation | (in psi) | min) | hr |
| 12 | chip | poloxamer 407 | toothpaste | room temp | 0.5 | constant | 100 | none | 70/8 |
| | [3] | (1) [5] | (5) | | | | | | |
| 13 | chip | poloxamer 407 | whitening | room temp | 1 | constant | 50 | 5 | 140/4 |
| | [4] | (2) [10] | (8) | | | | | | |
| 14 | chip | poloxamer 407 | antimicrobial | 60 | 4 | intermittent | 50 | 10 | 180/4 |
| | [5] | (5) [4] | (3) | | | | | | |
| 15 | chip | poloxamer 407 | anti-caries | 75 | 8 | intermittent | 10 | 5 | 80/48 |
| | [1] | (10) [3] | (4) | | | | | | |
| 16 | chip | poloxamer 407 | abrasive | 75 | 12 | constant | 10 | 10 | 100/24 |
| | [2] | (10) [8] | (12) | | | | | | |
| 17 | very thick | poloxamer 407 | vitamin | 75 | 16 | none | none | none | 120/16 |
| | [3] | (5) [20] | (6) | | | | | | |
| 18 | twist | poloxamer 407 | conditioner | 80 | 24 | none | none | 5 | 100/12 |
| | [4] | (2) [30] | (4) | | | | | | |

TABLE 4
Emulsion Impregnated Wet Rawhide Chews with Chlorhexidine

| | Types | | | | | | | | |
|---|---|---|---|---|---|---|---|---|---|
| | of Wet Chews | | | | | | | | |
| | (Type of physical | Emulsion Type (level | Other | | | | | Rinsing with | |
| | penetration) | of PDMS in %) | ingredients in | Water Soak Conditions | | | | warm water | Drying Temp |
| Ex. | [Reference is to | [concentration of | Emulsion | Temp | | | Pressure (in | (duration in | in ° C./time in |
| No. | FIGS. 1-5] | emulsion in %] | (% by wt) | ° C. | Time hrs) | Agitation | (in psi) | min) | hr |
| 19 | fresh | poloxamer 407 | toothpaste | room temp | 0.5 | constant | 100 | none | 70/8 |
| | 5″ log roll, | (1) [5] | (5) | | | | | | |
| | 3″ diameter | | | | | | | | |
| | [5] | | | | | | | | |
| 20 | dried | poloxamer 407 | whitening | room temp | 1 | constant | 50 | 5 | 140/4 |
| | 5″ log roll | (2) [10] | (8) | | | | | | |
| | 3″ diameter | | | | | | | | |
| | [1] | | | | | | | | |
| 21 | fresh | poloxamer 407 | antibiotic | 60 | 4 | intermittent | 50 | 10 | 180/4 |
| | open twist | (5) [4] | (3) | | | | | | |
| | [2] | | | | | | | | |
| 22 | dried | poloxamer 407 | anti-caries | 75 | 8 | intermittent | 10 | 5 | 80/48 |
| | open twist | (10) [3] | (4) | | | | | | |
| | [3] | | | | | | | | |
| 23 | fresh tight twist | poloxamer 407 | abrasive | 75 | 12 | constant | 10 | 10 | 100/24 |
| | [4] | (10) [8] | (12) | | | | | | |
| 24 | dried tight twist | poloxamer 407 | vitamin | 75 | 16 | none | none | none | 120/16 |
| | [5] | (5) [20] | (6) | | | | | | |
| 25 | pressed stick | poloxamer 407 | conditioner | 80 | 24 | none | none | 5 | 100/12 |
| | [—] | (2) [30] | (4) | | | | | | |

### EXAMPLE 26

Squares of dried rawhide, 3 inches by 3 inches, are soaked in the impregnation solution of Example 4 until flexible. They are then fed into the nip between two rollers. The top roller, 6 inches in diameter, is fitted with hollow punch needles of about 1/4 inch long and 1/8 inch in diameter at the base spaced every 1/4 inch around the roller. The bottom roller is fitted with a polyurethane sleeve against which the punch needles contact after cutting through the rawhide. The rawhide pieces are removed from the top roller with a sliding shoe and transferred back to the impregnation solution of Example 4 for the remainder of the impregnation time. They are then dried at 130° F. for 48 hours. The rawhide pieces are dry to the touch and colorless. As the dog chews the rawhide sample, MICRODENT® (Poloxamer+PDMS) and other agents are released, while no visible contamination is transferred to the carpet.

### EXAMPLE 27

Sections of fresh rawhide about 18 inches by 36 inches are placed in a press having its upper plate fitted with hollow punch needles about V2 inch long and 1/16 inches in diameter and 1/4 inches in diameter according to FIG. 5. The lower plate of the press is a high impact polyurethane sheet against which the press punches compress after cutting through the fresh rawhide. The fresh rawhide is then soaked impregnated according to Example 1. After impregnation, the fresh rawhide is cut to any desired size and shaped as required. It is then dried in a manner appropriate for the size and thickness of the piece.

What is claimed is:

1. Physically disrupted/penetrated rawhide pet chews impregnated with emulsions containing chlorhexidine, wherein: (a) said emulsion are impregnated substantially throughout said rawhide pet chew imparting plasticizing and enhanced biofilm fighting efficacy to said chew, and (b) said chlorhexidine remains antimicrobially active over the chew life of said rawhide chew.

2. Physically disrupted/penetrated rawhide pet chews impregnated with an emulsion comprising a coating substance as the discontinuous phase and a surfactant as the continuous phase containing chlorhexidine, wherein: (a) said emulsion is present in said rawhide at from between about 0.1 and about 30% by weight, (b) said impregnated rawhide chew helps control biofilm formation in the oral cavity of pets by releasing antimicrobially active chlorhexidine over the chew life of said pet chew, (c) said emulsion contains other ingredients selected from the group consisting of flavorants, conditioners, mouthfeel agents and mixtures thereof.

3. Rawhide pet chews according to claim 2, wherein said rawhide is selected from the group consisting of fresh rawhide, dried rawhide, compressible rawhide, comminuted rawhide and mixtures thereof.

4. Rawhide pet chews according to claim 2, wherein said emulsion is comprised of a surfactant substance as the continuous phase selected from the group consisting of:
sodium lauryl sulfate,
sodium lauryl sarcosinate,
polyethyleneglycol stearate,
polyethyleneglycol monostearate,
coconut monoglyceride sulfonates,
soap powder,
sodium alkyl sulfates,
sodium alkyl sulfoacetates,
alkyl polyglycol ether carboxylates such as those described in U.S. Pat. No. 4,130,636 polyoxyethylene derivatives or sorbitan esters, such as those described in U.S. Pat. No. 4,130,636,
polyoxyethylene derivatives or sorbitan esters, such as those described in U.S. Pat. Nos. 3,639,563 and 3,947,570,
propoxylated cetyl alcohol as described in U.S. Pat. No. 2,677,700, and preferred commercially available substances which include:
polyoxyethylene-polyoxypropylene block copolymers such as Pluronic F 108, and F127 (BASF) and polysorbates such as Tween 40 and 80 (Hercules); Particularly preferred surfactants include block copolymers comprising a congeneric mixture of conjugated polyoxypropylene and polyoxyethelene compounds having a hydrophobe, a polyoxypropylene polymer of at least 1200 molecular weight; such as described in U.S. Pat. Nos. 4,343,785; 4,465,663; 4,511,563 and 4,476,107; and mixtures thereof.

5. Rawhide pet chews according to claim 2, wherein said emulsion is comprised of a coating substance as the discontinuous phase selected from the group consisting of:
silicone glycol co-polymers,
polydimethylsiloxanes at molecular weights up to 25 million cs,
long chain hydrocarbons, especially normal paraffins having a chain length of 16 carbon atoms or greater, paraffins with several loci of branching and unsaturation does not create unacceptable toxicity nor lower the solidification point below body temperature,
Carbowaxes® (polyethylene glycols) and polymers which have limited solubility in ethanol and water solutions where the ethanol or water ratio is greater than 0.3:1 but have essentially no solubility in water or saliva at lower ratios; and mixtures thereof.

6. A method for helping to control biofilm formation in the oral cavity of pets comprising periodically providing the pet with an emulsion impregnated rawhide pet chew, wherein: (a) the emulsion is comprised of a surfactant continuous phase and a coating substance as the discontinuous phase and contains chlorhexidine, and (b) said pet chew releases antimicrobially active chlorhexidine over its chew-life.

7. A method for impregnating dried rawhide pet chews with an emulsion containing chlorhexidine comprising physically disrupting/penetrating the rawhide and soaking said rawhide in an aqueous bath containing an emulsion comprised of surfactant as the continuous phase, a coating substance as a discontinuous phase and chlorhexidine, wherein: (a) said soaking is carried out over a wide range of temperatures and over a wide range of soaking durations, (b) said emulsion impregnates substantially throughout said rawhide at from between about 0.1 and 30% by weight, and (c) said chlorhexidine remains antimicrobially active over the chew life of said pet chew.

8. A method for impregnating fresh rawhide suitable for use as pet chews with an emulsion containing chlorhexidine comprising physically disrupting/penetrating said rawhide and marinating said fresh rawhide in a soak wherein: (a) from between about 2 and about 10% by weight of said rawhide is impregnated with said emulsion, and (b) said chlorhexidine contained substantially throughout said pet chew remains antimicrobially active over the chew life of the said pet chew.

9. A method according to claim 8, wherein fresh rawhide is marinated in an aqueous soak at temperatures ranging from between about room temperature and up to about 80° C. for between about 1 hour and about 24 hours.

10. A method for impregnating dried rawhide suitable for use as pet chews with emulsions containing chlorhexidine, comprising physically disrupting/penetrating followed by soaking said rawhide in a soak, wherein: (a) from between about 2 and about 10% by weight of said dried rawhide is impregnated with said emulsion containing chlorhexidine, and (b) the chlorhexidine remains antimicrobially active over the chew life of said pet chew.

11. A method according to claim 10, wherein dried rawhide is impregnated using an aqueous soak at temperatures ranging from between about room temperature and up to about 80° C. for between about 1 hour and about 24 hours.

12. A method according to claim 8, wherein the impregnated pet chew is redried at a temperature ranging from between about 70° F. and about 140° F.

13. A method according to claim 10, wherein the impregnated pet chews is redried at a temperature ranging from between about 70° F. and about 140° F.

14. Rawhide pet chews impregnated substantially throughout with a melt emulsion comprising surfactant as the continuous phase and a coating substance as the discontinuous phase and chlorhexidine, wherein chemotherapeutically active chlorhexidine is releasable from the rawhide during chewing.

15. A method for treating gum disease in pets comprising periodically providing the pet with a rawhide chew impregnated with an emulsion of surfactant and coating substance containing chlorhexidine, wherein the chlorhexidine is antimicrobially active when released from said toy during chewing.

16. A method for manufacturing therapeutic rawhide pet chews comprising impregnating substantially throughout said rawhide an emulsion of surfactant and coating substance containing antimicrobially active chlorhexidine.

17. A rawhide pet chew according to claim 14, wherein said chew is simultaneously impregnated with said melt emulsion containing chlorhexidine and other ingredients.

18. A rawhide pet chew according to claim 14, wherein said chew is impregnated with said melt emulsion containing chlorhexidine and flavorants.

19. Rawhide pet chews according to claim 14, wherein said rawhide is selected from the group of fresh, dried, comminuted rawhide and mixtures thereof.

20. A rawhide pet chew according to claim 14, wherein said chlorhexidine is selected from the group consisting of chlorhexidine digluconate, chlorhexidine diacetate, chlorhexidine dilactate and mixtures thereof.
